(19) United States
(12) Patent Application Publication
(10) Pub. No.: US 2004/0098261 A1
(43) Pub. Date: May 20, 2004

(54) Information processing apparatus and information processing method

(75) Inventors: Kazue Kaneko, Kanagawa (JP); Michio Aizawa, Kanagawa (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 10/687,697

(22) Filed: Oct. 20, 2003

(30) Foreign Application Priority Data
Oct. 21, 2002 (JP) 2002-305832

(51) Int. Cl. G10L 13/00

(52) U.S. Cl. 704/258

(57) ABSTRACT

The information processing apparatus includes a manipulation procedure database 104 in which manipulation procedures selectable by a user are described hierarchically. Then, the information processing apparatus judges a manipulation procedure selected by the user, and if a manipulation procedure of a hierarchy lower in order than the judged manipulation procedure exists, synthesizes voice information on the manipulation procedure of the lower hierarchy in a voice synthesizing processing unit 105 using a dictionary for voice synthesizing 106, and outputs the voice information from a voice output unit 107. In addition, if a manipulation procedure of a hierarchy lower in order than the judged manipulation procedure does not exist, the information processing apparatus transitions to a manipulation procedure which is a manipulation procedure of a top hierarchy and is different form a manipulation procedure of a top hierarchy of the manipulation procedure, and voice information of the top hierarchy to which the information processing apparatus has transitioned is outputted.

### FIELD OF THE INVENTION

The present invention relates to an information processing apparatus and an information processing method which support a manipulation of an image forming apparatus with voice guidance.

### BACKGROUND OF THE INVENTION

Conventionally, in an image forming apparatus such as a printer or a copying machine, a manipulation screen is displayed on a monitor, and a user uses a soft key on a screen or a hard key such as a ten key or a start button to perform a manipulation. On the other hand, in order to cope with visually handicapped users, some image forming systems offer voice guidance to a user, and the user performs a manipulation using YES/NO keys in accordance with the voice guidance.

However, there is a disadvantage that, with a manipulation according to one-way voice guidance from a system side, a longer time is required for the manipulation in an image forming apparatus having various functions. In addition, concerning a function set in default on the system side, a user cannot determine whether or not the user may use the default unless he/she is advised in the beginning. Therefore, in the conventional system, there is no way but to inform the user of all the functions or to guide the user for limited available functions. Moreover, in the case in which buttons to be manipulated are located in different positions depending upon functions or the case in which buttons are located in distant places, the user is forced to bear another burden of looking for the buttons.

### SUMMARY OF THE INVENTION

The present invention has been proposed to solve the conventional problems, and has as its objects to provide an information processing apparatus and an information processing method which can preferably perform various settings under the control of a user and can reduce manipulation time or burden on the user required for a manipulation.

In order to solve the above-described problems, an information processing apparatus in accordance with the present invention is characterized by comprising: a manipulation procedure database in which manipulation procedures selectable by a user are described hierarchically; judging unit which judges a manipulation procedure selected by the user; first voice output unit which, in the case in which a manipulation procedure of a hierarchy lower in order than the manipulation procedure judged by the judging unit exists, outputs voice information on the manipulation procedure of the lower hierarchy; transition unit with which, in the case in which a manipulation procedure of a hierarchy lower in order than the manipulation procedure judged by the judging unit does not exist, a manipulation transitions to a manipulation procedure of a top hierarchy which is different from a manipulation procedure of a top hierarchy of the manipulation procedure; and second voice output unit which outputs voice information on the manipulation procedure of the top hierarchy to which the manipulation has transitioned.

In addition, the information processing apparatus in accordance with the present invention is characterized by further comprising re-selection unit which, in a hierarchy in which the user has selected a manipulation procedure, re-selects a manipulation procedure in the hierarchy.

Moreover, the information processing apparatus in accordance with the present invention is characterized by further comprising default setting unit which, in the case in which a manipulation transitions to a higher hierarchy without selecting any manipulation procedure in a predetermined hierarchy, sets a default manipulation procedure in the predetermined hierarchy.

Furthermore, the information processing apparatus in accordance with the present invention is characterized by further comprising voice re-output unit which, during voice output of voice information on the manipulation procedure, outputs voice again from voice information on a manipulation procedure immediately before the manipulation procedure for which voice information is being outputted presently.

Furthermore, the information processing apparatus in accordance with the present invention is characterized by further comprising state transition unit which, during voice output of voice information on the manipulation procedure, stops the voice output of the voice information to return the manipulation procedure to a state immediately before the voice output.

Furthermore, the information processing apparatus in accordance with the present invention is characterized in that, in the case in which an instruction to transition to a higher hierarchy is issued during voice output of voice information on the manipulation procedure, the information processing apparatus stops-the voice output of the voice information and sets a default manipulation procedure to transition to the higher hierarchy.

Furthermore, the information processing apparatus in accordance with the present invention is characterized by comprising: a manipulation procedure database in which manipulation procedures selectable by a user are described hierarchically; voice output unit which outputs information on a manipulation procedure selectable by the user as voice; judging unit which judges a manipulation procedure selected by the user while the voice output unit is outputting voice; transition unit with which, in the case in which a manipulation procedure of a hierarchy lower in order than the manipulation procedure judged by the judging unit exists, a manipulation transitions to the lower hierarchy; and default setting unit which sets a default manipulation procedure in a predetermined hierarchy.

Furthermore, the information processing apparatus in accordance with the present invention is characterized in that, in the case in which a default manipulation procedure is selected in a top hierarchy, the default setting unit sets manipulation procedures in all hierarchies to the default manipulation procedure.

Furthermore, the information processing apparatus in accordance with the present invention is characterized by further comprising deciding unit which decides the manipulation procedure, and in that, in the case in which the manipulation procedure is decided without outputting voice information on the manipulation procedure in a predetermined hierarchy, the default setting unit sets a default manipulation procedure in the hierarchy, and the transition unit returns the hierarchy to a hierarchy immediately higher in order than the hierarchy.

Furthermore, the information processing apparatus in accordance with the present invention is characterized in that, in the case in which an instruction to transition to a different hierarchy is issued during output of voice information on a manipulation procedure in a predetermined hierarchy, the voice output unit skips the manipulation procedure, for which voice is being outputted presently, and outputs voice information on a manipulation procedure of the different hierarchy as voice and, in the case in which an instruction to return to a preceding manipulation procedure is issued during output of voice information on the manipulation procedure in the predetermined hierarchy, the voice output unit outputs voice again from voice information on a manipulation procedure immediately preceding the manipulation procedure for which voice is being outputted presently.

Furthermore, the information processing apparatus in accordance with the present invention is characterized in that voice information on the manipulation procedure is a manipulation procedure name selectable by the user.

Furthermore, the information processing apparatus in accordance with the present invention is characterized by comprising: a plurality buttons which are associated with different manipulation procedures, respectively, and correspond to a plurality of fingers of the user; and reception unit which receives information on which of the plurality of buttons is depressed by the user, and in that the judging unit judges a manipulation procedure corresponding to the depressed button for which information is received by the reception unit.

Furthermore, the information processing apparatus in accordance with the present invention is characterized in that the plurality of buttons can be operated with positions of the plurality of fingers fixed, respectively.

Furthermore, the information processing apparatus in accordance with the present invention is characterized in that the plurality of buttons are allocated to a part of a ten key.

Furthermore, the information processing apparatus in accordance with the present invention is characterized in that the predetermined processing apparatus is a copying machine and the manipulation procedure is a setting function for a copying manipulation selectable by the user in the copying machine.

Furthermore, the information processing apparatus in accordance with the present invention is characterized by further comprising deciding unit which decides the manipulation procedure, and in that, in the case in which a manipulation procedure is decided without outputting voice information on the manipulation procedure in a predetermined hierarchy, the default setting unit sets a default manipulation procedure in the hierarchy.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a block diagram showing a constitution of an image forming system including an information processing apparatus in accordance with an embodiment of the present invention;

FIG. 2 is a flowchart for explaining a first example of voice synthesizing processing in the information processing apparatus in accordance with the embodiment of the present invention;

FIG. 3 is a flowchart for explaining a second example of voice synthesizing processing in the information processing apparatus in accordance with the embodiment of the present invention;

FIG. 4 is a diagram showing an example of a hierarchical structure of a manipulation procedure selectable by a user in the embodiment;

FIG. 5 is a diagram showing an example of arrangement of manipulation buttons for the user to perform button input in the embodiment;

FIG. 6 is a diagram for explaining an example of the case in which the manipulation buttons are allocated to a ten key;

FIG. 7 is a diagram for explaining an example of a manipulation by the user and voice guidance from the system in the flowchart shown in FIG. 2; and

FIG. 8 is a sequence diagram for explaining timing of event notification among a button input unit 102, a manipulation management unit 103, and a voice synthesizing unit 105.

### DETAILED DESCRIPTION OF THE PREFERRED EMBODIMENTS

An embodiment of the present invention will be hereinafter described in detail with reference to the accompanying drawings.

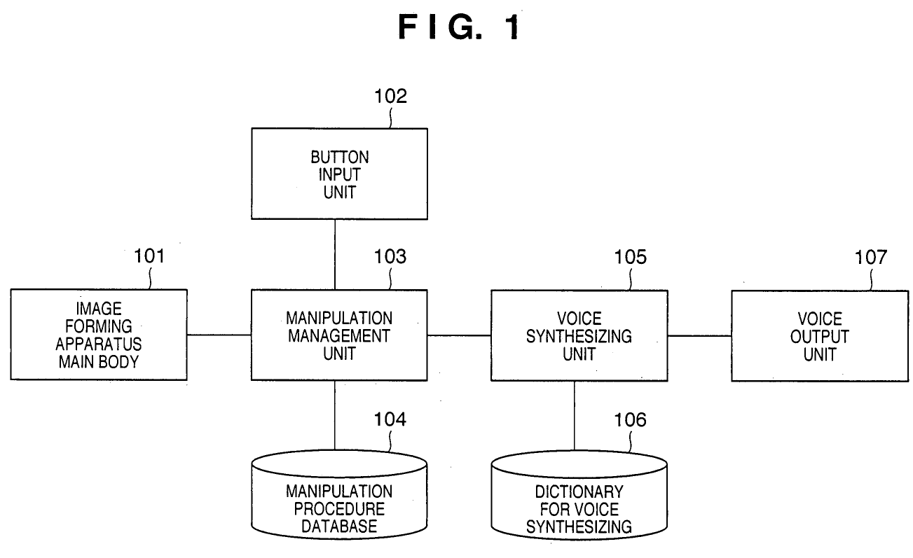

FIG. 1 is a block diagram showing a constitution of an image forming system including an information processing apparatus in accordance with an embodiment of the present invention. The information processing apparatus in accordance with this embodiment is an apparatus for supporting a manipulation or the like of an image forming apparatus main body 101 with voice guidance. As shown in FIG. 1, the information processing apparatus includes a button input unit 102 with which a user performs a button manipulation, a manipulation procedure database 104 in which manipulation procedures manipulatable by the user are described in a hierarchical structure, a dictionary for voice synthesizing 106 storing data used for voice synthesizing, a voice synthesizing unit 105 which synthesizes voice at the time when the manipulation procedures or the like manipulatable by the user are outputted as voice, and a manipulation management unit 103 which manages communication among a voice output unit 107 which outputs synthesized voice, the image forming apparatus 101, and the information processing apparatus.

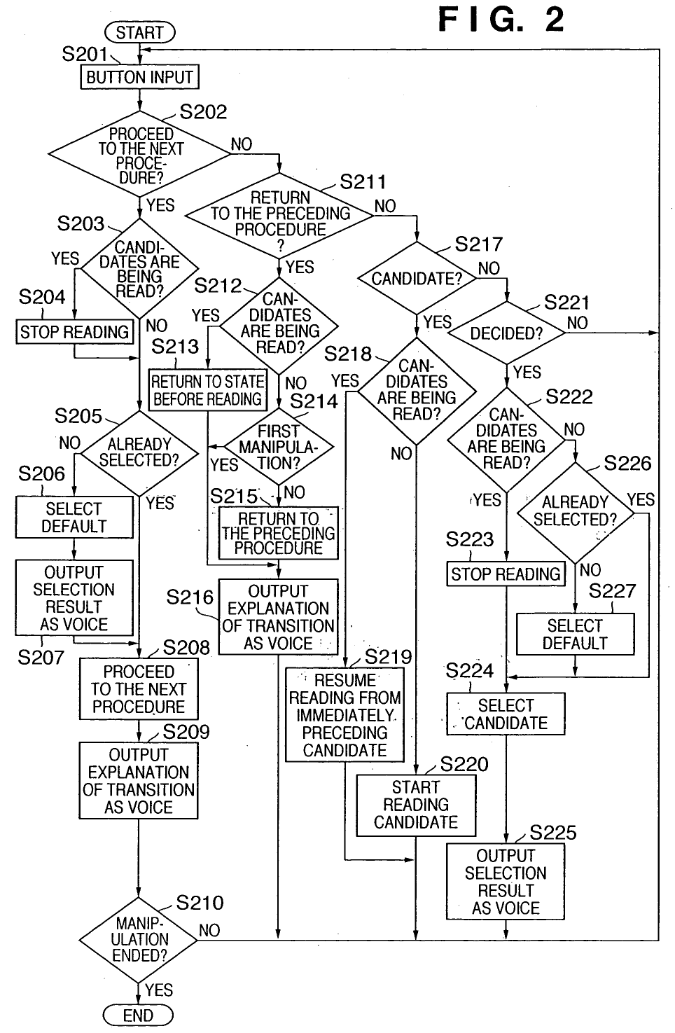

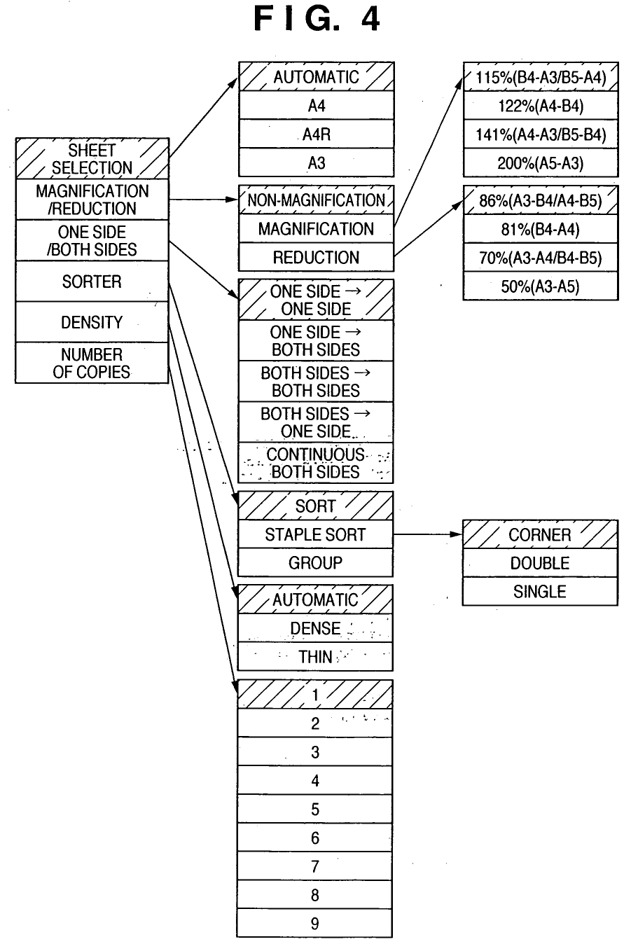

FIG. 2 is a flowchart for explaining a first example of voice synthesizing processing in the information processing apparatus in accordance with the embodiment of the present invention. In addition, FIG. 4 is a diagram showing an example of a hierarchical structure of manipulation procedures selectable by a user in this embodiment. That is, in this embodiment, there are manipulation procedures of “sheet selections”, “magnification/reduction”, “one side/both sides”, “sorter”, “density”, and “number of copies” as top hierarchies selectable by a user. Then, in the case in which the user selects any one of the manipulation procedures, a manipulation shifts to a manipulation procedure of a lower hierarchy of the manipulation procedure. Note that, in this embodiment, it is assumed that manipulations indicated by shading in the lower hierarchies are default manipulations.

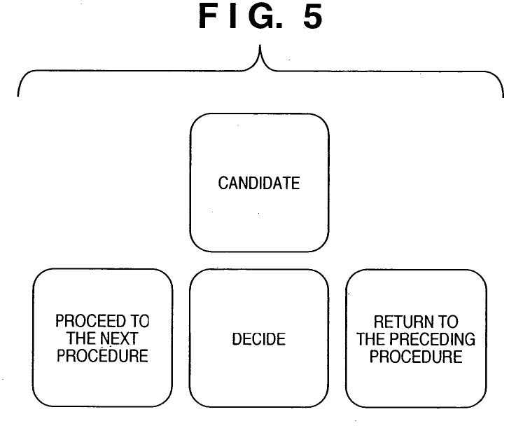

As shown in FIG. 2, first, it is judged whether a user has made any button input with the button input unit 102 (step S201). Here, if no button input has been made, the information processing apparatus stands by in that state. FIG. 5 is a diagram showing an example of arrangement of manipulation buttons for the user to perform button input in this embodiment. As shown in FIG. 5, in this embodiment, buttons for performing respective manipulations of “proceed to the next procedure”, “candidate”, “decide”, and “return to the preceding procedure” are arranged such that the buttons can be designated by three fingers, an index finger, a middle finger, and a ring finger. In this way, the manipulation buttons are arranged within an area in which the manipulation buttons can be manipulated with one hand with finger positions fixed. Consequently, if the user confirms a position of a manipulation button once, the user does not need to look for the button thereafter. Therefore, burden on the user is reduced. Then, next, in the information processing apparatus, in the case in which button input has been made by the user, it is judged for which manipulation the input is made.

That is, the information processing apparatus in accordance with this embodiment includes the button input unit 102 including a plurality of buttons, which are associated with different manipulation procedures, respectively, corresponding to a plurality of fingers of the user, and receives information on which one of the plurality of buttons has been depressed by the user. Further, the information processing apparatus is characterized by judging a manipulation procedure corresponding to the depressed button on which the information has been received by the information processing apparatus. In addition, the information processing apparatus in accordance with this embodiment is characterized in that the user is capable of manipulating the plurality of buttons with the positions of the plurality of fingers fixed, respectively.

The information processing apparatus judges whether or not the “proceed to the next procedure” button has been depressed (step S202). As a result of the judgment, if it is judged that input by the “proceed to the next procedure” button has been made (Yes), the information processing apparatus judges whether or not candidates are being read presently. Here, in this embodiment, it is assumed that reading processing is operating in another process or another thread, and when a start command is issued, reading is started, and completion of the reading is notified at a stage when it has been completed.

As a result of the judgment, if it is judged that candidates are being read (Yes), the information processing apparatus stops the reading presently being performed (step S204), and proceeds to step S205. On the other hand, if it is judged that candidates are not being read (No), the information processing apparatus proceeds to step S205 directly. In step S205, the information processing apparatus judges whether or not selection of a candidate has already been made. As a result of the judgment, if the selection of a candidate has not been made (No), the information processing apparatus selects default (step S206). That is, the information processing apparatus in accordance with this embodiment is characterized in that, in the case in which no manipulation procedure is selected in a certain hierarchy and a manipulation transitions to the next manipulation procedure of a higher hierarchy, a default manipulation procedure is set in the hierarchy. Subsequently, the information processing apparatus outputs the selected default as voice (step S207), and proceeds to step S208. On the other hand, if it is judged in step S205 that a candidate has been selected (Yes), the information processing apparatus proceeds to step S208. That is, the information processing apparatus in accordance with this embodiment is characterized in that, in the case in which an instruction to transition to a lower hierarchy is issued during voice output of voice information on a manipulation procedure, the information processing apparatus stops the voice output of the voice information, and sets a default manipulation procedure to transition to the next manipulation procedure of the lower hierarchy.

In step S208, the information processing apparatus proceeds to the next manipulation in step S208, and by outputting voice, explains that the manipulation has transitioned (step S209). Then, the information processing apparatus judges whether or not all manipulations have been performed for manipulation procedures of a top hierarchy (step S210) shown in FIG. 4. As a result of the judgment, if all the manipulations have been performed (Yes), the information processing apparatus ends the processing. On the other hand, if there remain manipulations (No), the information processing apparatus returns to step S201 to repeat the processing from the button input.

In addition, if it is judged in step S202 that the button input is not made by depressing the “proceed to the next procedure” button (No), the information processing apparatus judges whether or not the “return to the preceding procedure” button has been depressed (step S211). As a result of the judgment, if it is judged that the “return to the preceding procedure” button has been depressed (Yes), the information processing apparatus judges whether or not candidates are being read presently (step S212). As a result of the judgment, if it is judged that candidates are being read (Yes), the information processing apparatus returns to a state before starting the reading (step S213) to proceed to step S216. That is, the information processing apparatus in accordance with this embodiment is characterized in that, during voice output of voice information on a manipulation procedure, voice output is performed again from voice information on a manipulation procedure immediately preceding the manipulation procedure for which voice information is being outputted presently.

On the other hand, if it is judged in step S212 that candidates are not being read (No), the information processing apparatus judges whether or not a first manipulation of a manipulation procedure is performed (step S214). As a result of the judgment, if there is a manipulation procedure preceding it (No), the information processing apparatus returns to the preceding processing (step S215), and proceeds to step S216. On the other hand, if the first manipulation is performed (Yes), the information processing apparatus proceeds to step S216 directly. In step S216, the information processing apparatus performs voice output about the manipulation in order to inform the user for which manipulation a setting is made presently. Thereafter, the information processing apparatus returns to step S201 to repeat the processing from the button input. That is, the information processing apparatus in accordance with this embodiment is characterized in that, in a hierarchy for which the user has selected a manipulation procedure, re-selection of a manipulation procedure in the hierarchy is possible.

In addition, if it is judged in step S211 that the button input is not made by depressing the “return to the preceding procedure” button (No), the information processing apparatus judges whether or not the “candidate” button has been depressed (step S217). As a result of the judgment, if it is judged that the “candidate” button has been depressed (Yes), the information processing apparatus judges whether or not candidates are being read presently (step S218). As a result of the judgment, if it is judged that candidates are being read (Yes), the information processing apparatus stops the reading being performed presently, and resumes reading from a candidate immediately preceding the candidate being read (step S219). Then, the information processing apparatus returns to step S201 to repeat the processing from the button input.

On the other hand, if it is judged in step S218 that candidates are not being read (No), the information processing apparatus starts reading of candidates (step S220) and returns to step S201 to repeat the processing from the button input.

In addition, if it is judged in step S217 that the button input is not made by depressing the “candidate button” (No), the information processing apparatus judges whether or not the “decision” button has been depressed (step S221). As a result of the judgment, if it is judged that the “decision” button has not been depressed (No), the information processing apparatus returns to step S201 to repeat the processing from the button input. On the other hand, if it is judged that the “decision” button has been depressed (Yes), the information processing apparatus judges whether or not candidates are being read presently (step S222). As a result of the judgment, if it is judged that candidates are being read (Yes), the information processing apparatus stops the reading (step S223) and selects a candidate just read (step S224) to proceed to step S225. That is, the information processing apparatus in accordance with this embodiment is characterized in that, during voice output of voice information on a manipulation procedure, the voice output of the voice information is stopped and the manipulation procedure is selected.

On the other hand, if it is judged in step S222 that candidates are not being read (No), the information processing apparatus judges whether or not a candidate has already been selected (step S226). As a result of the judgment, if a candidate has not been selected (No), the information processing apparatus performs default candidate selection (step S227) and proceeds to step S225. In addition, if it is judged in step S226 that a candidate has been selected (Yes), the information processing apparatus proceeds to step S225 directly. Note that, as an example of the case in which it is judged in step S226 that a candidate has already been selected, a case in which the “decision” button is depressed continuously is assumed. In that case, it is assumed that the user confirms a selection result. In step S225, the information processing apparatus outputs the selection result as voice. Thereafter, the information processing apparatus returns to step S201 to repeat the processing from the button input.

That is, the information processing apparatus in accordance with this embodiment includes the manipulation procedure database 104 in which manipulation procedures selectable by a user manipulating the image forming apparatus main body 101 are described hierarchically, judges a manipulation procedure selected by the user for each hierarchy, and if a manipulation procedure of a hierarchy lower in order than the judged manipulation procedure exists, synthesizes voice information on the manipulation procedure of the lower hierarchy in the voice synthesizing processing unit 105 using the dictionary for voice synthesizing 106, and outputs the voice information from the voice output unit 107. In addition, the information processing apparatus is characterized in that, if a manipulation procedure of a hierarchy lower in order than the judged manipulation procedure does not exist, a manipulation transitions to a manipulation procedure which is a manipulation procedure of a top hierarchy and is different from a manipulation procedure of a top hierarchy of the manipulation procedure, and voice information on the manipulation procedure of the top hierarchy to which the manipulation has transitioned is outputted from the voice output unit 107. In addition, the information processing apparatus in accordance with this embodiment is characterized in that, in a predetermined hierarchy, voice information on a manipulation procedure is outputted as voice repeatedly until selection of a manipulation procedure or transition of a hierarchy is performed.

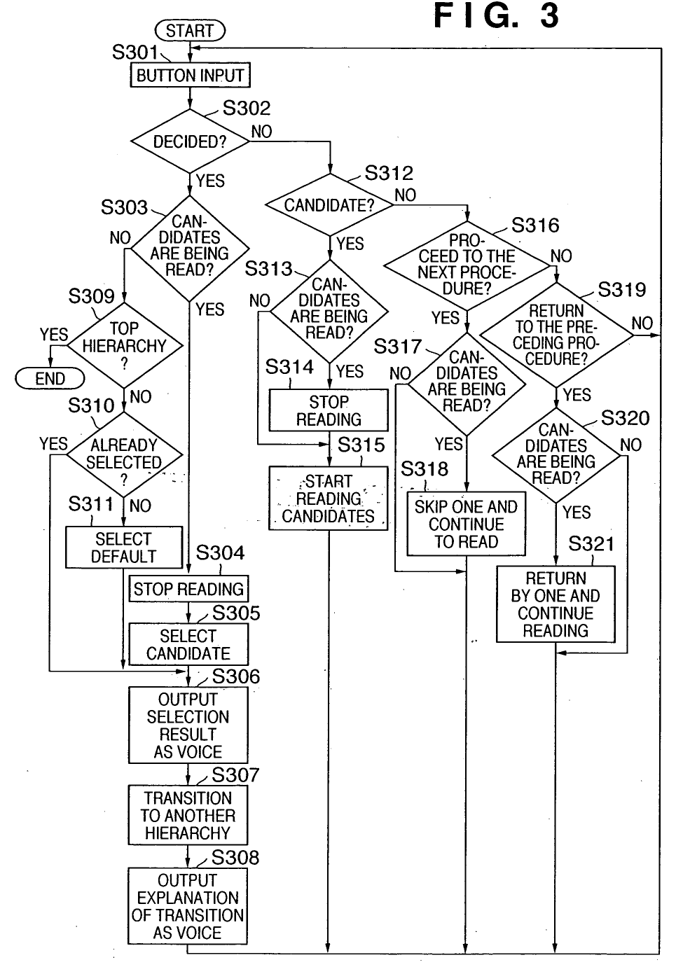

FIG. 3 is a flowchart for explaining a second example of voice synthesizing processing in the information processing apparatus in accordance with the embodiment of the present invention. In the flowchart shown in FIG. 2, top manipulation procedures of the hierarchies of manipulation procedures in FIG. 4 are set one after another by the “proceed to the next procedure” button. On the other hand, in the example shown in the flowchart of FIG. 3, first, the “candidate” button is depressed to read top manipulation procedures as candidates and select a manipulation procedure with the “decision” button, and then, a manipulation procedure lower in order than the selected manipulation procedure is selected from the candidates. Therefore, when the “decision” button is depressed when the candidates are not being read in the case in which the processing is in a top manipulation procedure, all the manipulations are considered to be completed. For example, when the “decision” button is depressed in a state in which no setting is made, default is set for the entire processing. That is, the information processing apparatus in accordance with this embodiment is characterized in that, in the case in which a default manipulation procedure is selected in a top hierarchy, manipulation procedures of all the hierarchies are set to default manipulation procedures.

As shown in FIG. 3, first, when a user performs button input, the button input unit 102 of the information processing apparatus receives the button input (step S301). Here, if no button input is performed, the information processing apparatus stands by in that state. Next, the information processing apparatus judges whether or not the button input has been made by depressing the “decision” button (step S302). As a result of the judgment, if it is judged that the button input has been made by depressing the “decision” button (Yes), the information processing apparatus judges whether or not candidates are being read (step S303). Here, if it is judged that candidates are not being read (No), the information processing apparatus judges whether or not a hierarchy of a current manipulation procedure is a top hierarchy (step S309). Then, if it is judged that it is a top hierarchy (Yes), the information processing apparatus ends the processing.

On the other hand, if it is judged in step S309 that the current manipulation procedure hierarchy is a lower hierarchy (No), the information processing apparatus judges whether or not a candidate has been selected (step S310). As a result of the judgment, if a candidate has not been selected (No), the information processing apparatus selects default (step S311) and proceeds to step S306. In addition, if it is judged in step S310 that a candidate has been selected (Yes), the information processing apparatus proceeds to step S306. Note that, as the case in which candidates are not being read and a candidate has been selected, for example, a case in which processing of a top hierarchy already set is selected again, or the like is assumed in step S310.

In step S306, the information processing apparatus performs voice output of a selection result, and subsequently performs transition of a hierarchy according to the selection result (step S307). For example, if “sheet selection” is selected in FIG. 4, the information processing apparatus shifts to a manipulation procedure hierarchy below it. Then, if “automatic” is selected in the manipulation procedure hierarchy, the information processing apparatus shifts to a manipulation procedure hierarchy above it. Then, the information processing apparatus performs voice output explaining a result of the transition in step S308, and thereafter returns to step S301 to repeat the processing from the button input. That is, the information processing apparatus in accordance with this embodiment is characterized by further including deciding unit (decision button) which decides a manipulation procedure, and in that, in the case in which a manipulation procedure is decided without outputting voice information on a manipulation procedure in a certain hierarchy, the information processing apparatus sets a default operation procedure in the hierarchy and returns the hierarchy to a hierarchy immediately higher in order than it.

On the other hand, if it is judged in step S303 that candidates are being read (Yes), the information processing apparatus stops the reading (step S304), selects a candidate read immediately before stopping the reading (step S305), and proceeds to step S306. Note that the processing in step S306 and subsequent steps is as described above.

In addition, if it is judged in step S302 that the button input is not made by depressing the “decision” button (No), the information processing apparatus judges whether or not the button input has been made by depressing the “candidate” button (step S312). As a result of the judgment, if it is judged that the button input has been made by depressing the “candidate” button (Yes), the information processing apparatus judges whether or not candidates are being read presently (step S313). As a result of the judgment, if it is judged that candidates are being read (Yes), the information processing apparatus stops the reading (step S314) and proceeds to step S315. On the other hand, if it is judged that candidates are not being read (No), the information processing apparatus proceeds to step S315 directly. In step S315, the information processing apparatus starts reading candidates and returns to step S301 to repeat the processing from the button input.

In addition, if it is judged in step S312 that the button input has not been made by depressing the “candidate” button (No), the information processing apparatus judges whether or not the button input has been made by depressing the “proceed to the next procedure” button (step S316). As a result of the judgment, if it is judged that the button input has been made by depressing the “proceed to the next procedure” button (Yes), the information processing apparatus judges whether or not candidates are being read presently (step S317). Then, if it is judged in step S317 that candidates are being read (Yes), the information processing apparatus stops the reading of a candidate being read presently, resumes reading from the next candidate (step S318), and returns to step S301 to repeat the processing from the button input. On the other hand, if it is judged in step S317 that candidates are not being read (No), the information processing apparatus returns to step S301 without performing anything to repeat the processing from the button input.

In addition, if it is judged in step S316 that the button input has not been made by depressing the “proceed to the next procedure” button (No), the information processing apparatus judges whether or not the button input has been made by depressing the “return to the preceding procedure” button (step S319). As a result of the judgment, if it is judged that the button input has been made by depressing the “return to the preceding procedure” button (Yes), the information processing apparatus judges whether or not candidates are being read presently (step S320). Then, if candidates are being read (Yes), the information processing apparatus stops the reading of a candidate being read presently, resumes reading from the preceding candidate (step S321), and returns to step S301 to repeat the processing from the button input. That is, the information processing apparatus in accordance with this embodiment is characterized in that, in the case in which an instruction to transition to a different hierarchy is issued while the voice output unit 107 outputs voice information on a manipulation procedure in a certain hierarchy, the information processing apparatus skips a manipulation procedure for which voice output is being performed presently to output voice information on a manipulation procedure of the hierarchy, to which transition is instructed, as voice, and in the case in which an instruction to return to the preceding manipulation procedure is issued while the voice output unit 107 outputs voice information on a manipulation procedure in a certain hierarchy, the information processing apparatus performs voice outputs again from voice information on a manipulation procedure immediately preceding the manipulation procedure for which voice output is being performed presently.

On the other hand, if it is judged in step S320 that candidates are not being read (No), the information processing apparatus returns to step S301 without performing anything to repeat the processing from the button input. In addition, if it is judged in step S319 that the button input has not been made by depressing the “return to the preceding procedure” button (No), the information processing apparatus returns to step S301 without performing anything to repeat the processing from the button input.

That is, the information processing apparatus in accordance with this embodiment is connectable to or provided in the manipulation procedure database 104 in which manipulation procedures selectable by the user manipulating the image forming apparatus main body 101 are described hierarchically. Then, the information processing apparatus synthesizes information on a manipulation procedure selectable by a user for each hierarchy in the voice synthesizing processing unit 105 using the dictionary for voice synthesizing 106, and outputs the voice information from the voice output unit 107 as voice. Here, the information processing apparatus judges a manipulation procedure selected by the user during voice output, and if a manipulation -procedure of a hierarchy lower in order than the judged manipulation procedure exists, transitions to the lower hierarchy. In addition, the information processing apparatus is characterized by setting a default manipulation procedure in a predetermined hierarchy.

Note that, in the flowcharts shown in FIGS. 2 and 3, only the setting of functions for copying in the image forming apparatus is described and start of copying is not described. However, copying may be started directly after the “end” in each flowchart. In addition, setting of modes may be explained by voice to start copying when a user depresses the decision button. That is, the information processing apparatus in accordance with this embodiment is connectable to or provided in a copying machine, and is characterized in that a manipulation procedure is a set function for copying manipulation selectable by a user in the copying machine.

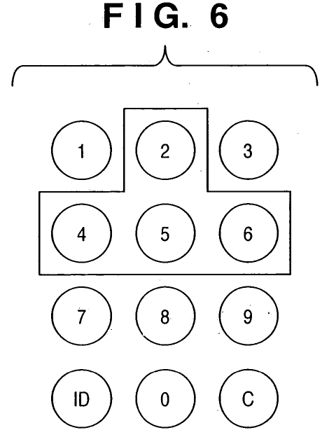

FIG. 6 is a diagram for explaining an example in the case in which operation buttons are allocated to a ten key. For example, with a button “5” in the center, “4”, “2”, “5”, and “6” are allocated to “proceed to the next procedure”, “candidate”, “decision”, and “return to the preceding procedure”, respectively. In this case, in order to perform this allocation, an ON/OFF button of “voice guidance” may be used. That is, the information processing apparatus in accordance with this embodiment is characterized in that a plurality of buttons are allocated to a part of the ten key.

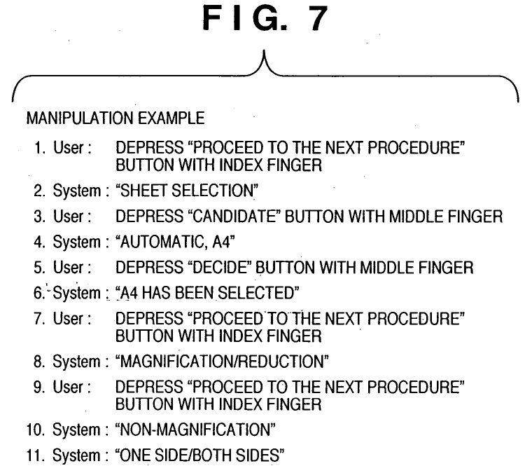

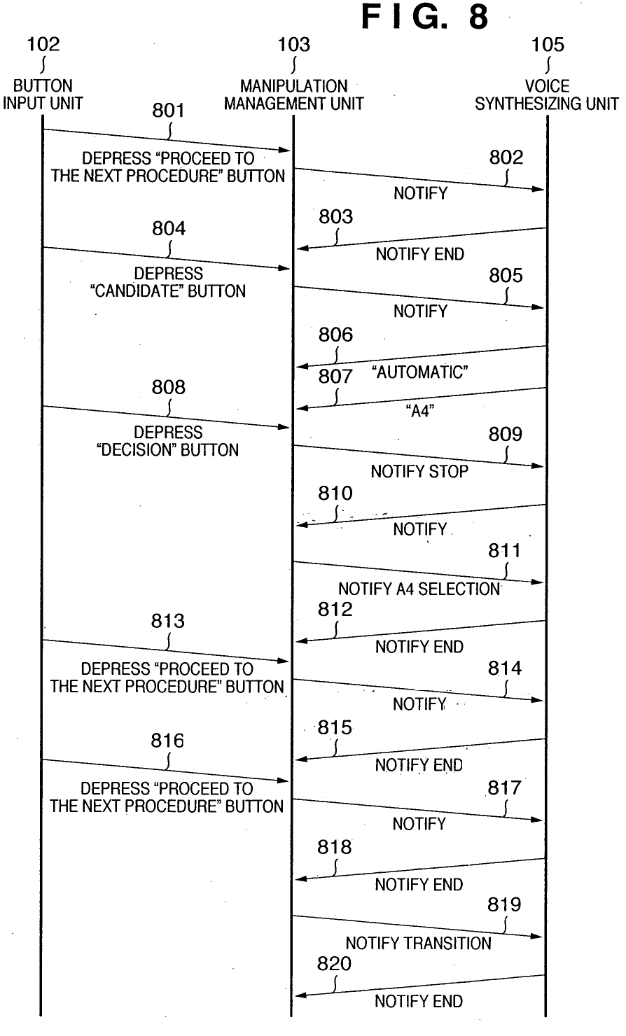

FIG. 7 is a diagram for explaining an example of a manipulation by the user and voice guidance from the system in the flowchart shown in FIG. 2. In FIG. 7, the user performs a button manipulation in a part of “User:” and voice output is performed in a part of “System:”. In addition, FIG. 8 is a sequence diagram for explaining timing of event notification among the button input unit 102, the manipulation procedure management unit 103, and the voice reading unit 105.

Next, an example of event notification in this embodiment will be described with reference to FIGS. 7 and 8. First, when the user depresses the “proceed to the next procedure” button with the index finger in the button input unit 102, the manipulation management unit 103 is notified to that effect (step S801). Then, the same contents are notified to the voice synthesizing unit 105 from the manipulation management unit 103 (step S802), and synthesizing of voice “sheet selection” is started in the voice synthesizing unit 105. Then, when output of the synthesized voice ends, the voice synthesizing unit 105 notifies the manipulation management unit 103 that the reading has ended (step S803).

Subsequently, when the user depresses the “candidate” button with the middle finger in the button input unit 102, the manipulation management unit 103 is notified to that effect (step S803). Then, the same contents are notified to the voice synthesizing unit 105 from the manipulation management unit 103 (step S805). In the voice synthesizing unit 105, voice synthesizing of candidates “automatic, A4, A4R, and A3” is started. Then, when reading “automatic”, which is one of the candidates, is started, the manipulation management unit 103 is notified to that effect (step S806). In addition, when reading of “A4” is started, the manipulation management unit 103 is notified to that effect (step S807).

Then, when the user depresses the “decision” button with the middle finger in the button input unit 102 at a point when “automatic, A4” is read, the manipulation management unit 103 is notified to that effect (step S808). The manipulation management unit 103 notifies the voice synthesizing unit 105 that the reading is to be stopped (step S809), and the voice synthesizing unit 105 notifies the manipulation management unit 103 that the reading has been stopped (step S810). Here, A4 is selected because it is a present candidate, and the manipulation management unit 103 notifies the voice synthesizing unit 105 that the candidate has been selected (step S811). Then, voice synthesizing of “A4 has been selected” is started, and the manipulation management unit 103 is notified to the effect that the voice synthesizing has ended (step S812).

Moreover, when the user depresses the “proceed to the next procedure” button with the index finger, the button input unit 102 notifies the manipulation management unit 103 to that effect (step S813). This instruction is notified to the voice synthesizing unit 105 from the manipulation management unit 103 (step S814), voice synthesizing of “magnification/reduction” is started in the voice synthesizing unit 105, and the manipulation management unit 103 is notified that the voice synthesizing has ended (step S815).

Moreover, when the user depresses the “proceed to the next procedure” button with the index finger, the manipulation management unit 103 is notified to that effect by the button input unit 102 (step S816). Here, since reading of candidates is not performed presently, default is selected, and the voice synthesizing unit 105 is notified to that effect by the manipulation management unit 103 (step S817). In the voice synthesizing unit 105, voice synthesizing of “not magnified” is started, and the manipulation management unit 103 is notified that the voice synthesizing has ended (step S818). In addition, the manipulation management unit 103 performs transition of a manipulation, and the voice synthesizing unit 105 is notified to that effect (step S819). In the voice synthesizing unit 105, voice synthesizing of “one side/both side” is started, and the manipulation management unit 103 is notified that the voice synthesizing has ended (step S820). That is, the information processing apparatus in accordance with this embodiment is characterized in that voice information on a manipulation procedure is a manipulation procedure name selectable by the user.

Note that the button manipulation with the index finger and the middle finger of the user is only an example, and naturally, a finger for performing a manipulation is not limited to these fingers.

As described above, in this embodiment, voice guidance and a button manipulation by a user are combined interactively, whereby the user can select a manipulation to be set and decide a candidate in the middle of reading of options by voice synthesizing, and it becomes possible to perform various settings under the control of the user without the user viewing a setting screen. Therefore, reduction of a manipulation time can be realized.

### Other Embodiment

In the above-described embodiment, only setting for copying in an image forming apparatus is performed. However, functions of a facsimile apparatus, a scanner, or the like in the image forming apparatus may be set as manipulation of a top hierarchy to select one of them and start setting processing. In that case, although manipulation procedures are different from each other individually, the manipulation procedures are the same in that they have a hierarchical structure as shown in FIG. 4. Therefore, it is possible to carry out the manipulation procedures in the same manner as described above.

In addition, in the above-described embodiment, concerning interruption during voice output, only reading of candidates is described. However, key input in the middle of reading may be allowed for explanation of a selection result or explanation of a transition result to stop the reading or invalidate a key input for the reading in progress in that case.

Moreover, in the above-described embodiment, a voice message of a voice output unit is generated by inserting a sentence from items in the manipulation procedure database 104. However, sentences to be actually read may be stored in a manipulation procedure message and sent to the voice-synthesizing unit 105.

Furthermore, in the above-described embodiment, a voice message to be outputted from the voice output unit 107 is generated by voice synthesizing processing for analyzing a sentence to read it out. However, voice may be recorded in advance and stored in the manipulation procedure database 104 to be reproduced. In this case., the voice synthesizing unit 105 and the dictionary for voice synthesizing 106 shown in FIG. 1 becomes unnecessary.

Furthermore, in the above-described embodiment, only one digit of “the number of copies” can be selected with the description of the manipulation procedure database 104 shown in FIG. 4. Thus, in the case in which an option is a numerical value with unlimited number of digits, it is also possible to read numerical values from 1 to 9 for a top one digit to perform a deciding manipulation among them, and if the numerical value has only one digit, continuously perform the deciding manipulation to decide the numerical value, and if the numerical value has the next digit, perform a reading manipulation of options to read the numerical values of 0 to 9 and perform the deciding manipulation among them, and repeat this manipulation until a desired numerical value is obtained.

Furthermore, the above-described information processing apparatus is connected to the image forming apparatus 101. However, it does not need to be connectable only to an image forming apparatus such as a printer or a copying machine but may be connected to another image processing apparatus or the like.

Note that the present invention may be applied to a system constituted by a plurality of apparatuses (e.g., a host computer, an interface apparatus, a reader, a printer, etc.) or may be applied to an apparatus consisting of one apparatus (e.g., a copying machine, a facsimile apparatus, etc.).

In addition, it is needless to mention that the object of the present invention can be attained by supplying a recording medium (or a storage medium), which has recorded therein a program code of software realizing the function of the above-described embodiment, to a system or an apparatus, and a computer (or a CPU or an MPU) of the system or the apparatus reading out to execute the program code stored in the recording medium. In this case, the program code itself read out from the recording medium realizes the function of the above-described embodiment, and the recording medium having recorded the program code therein constitutes the present invention. Further, it is needless to mention that the present invention includes not only the case in which the function of the above-described embodiment is realized by the computer executing the read out program code but also the case in which an operating system (OS) or the like running on the computer performs a part of or entire actual processing based upon an instruction of the program code, and the function of the above-described embodiment is realized by the processing.

Moreover, it is needless to mention that the present invention includes the case in which the program code read out from the recording medium is written in a memory provided in a function extended card inserted in the computer or a function extended unit connected to the computer, and then, a CPU or the like provided in the function extended card or the function extended unit performs a part of or entire actual processing based upon an instruction of the program code, and the function of the above-described embodiment is realized by the processing.

In the case in which the present invention is applied to the above-described recording medium, a program code corresponding to the flowchart described above is stored in the recording medium.

As described above, according to the present invention, various settings can be performed preferably under the control of a user, and reduction of a manipulation time and reduction of burden on the user required for a manipulation can be realized.

The present invention is not limited to the above embodiments and various changes and modification can be made within the spirit and scope of the present inventions. Therefore, to apprise the public of the scope of the present invention, the following claims are made.

What is claimed is:

1. An information processing apparatus comprising:
a manipulation procedure database in which manipulation procedures selectable by a user are described hierarchically;
judging unit which judges a manipulation procedure selected by the user;
first voice output unit which, in the case in which a manipulation procedure of a hierarchy lower in order than said manipulation procedure judged by said judging unit exists, outputs voice information on said manipulation procedure of the lower hierarchy;
transition unit with which, in the case in which a manipulation procedure of a hierarchy lower in order than said manipulation procedure judged by said judging unit does not exist, a manipulation transitions to a manipulation procedure of a top hierarchy which is different from a manipulation procedure of a top hierarchy of said manipulation procedure; and
second voice output unit which outputs voice information on said manipulation procedure of the top hierarchy to which the manipulation has transitioned.

2. The information processing apparatus according to claim 1, further comprising re-selection unit which, in a hierarchy in which the user has selected a manipulation procedure, re-selects a manipulation procedure in the hierarchy.

3. The information processing apparatus according to claim 1, further comprising default setting unit which, in the case in which the manipulation transitions to a higher hierarchy without selecting any manipulation procedure in a predetermined hierarchy, sets a default manipulation procedure in the predetermined hierarchy.

4. The information processing apparatus according to claim 1, further comprising voice re-output unit which, during voice output of voice information on said manipulation procedure, outputs voice again from voice information on a manipulation procedure immediately before said manipulation procedure for which voice information is being outputted presently.

5. The information processing apparatus according to claim 1, further comprising state transition unit which, during voice output of voice information on said manipulation procedure, stops the voice output of the voice information to return said manipulation procedure to a state immediately before the voice output.

6. The information processing apparatus according to claim 1,
wherein, in the case in which an instruction to transition to a higher hierarchy is issued during voice output of voice information on said manipulation procedure, the information processing apparatus stops the voice output of the voice information and sets a default manipulation procedure to transition to the higher hierarchy.

7. An information processing apparatus comprising:
a manipulation procedure database in which manipulation procedures selectable by a user are described hierarchically;
voice output unit which outputs information on a manipulation procedure selectable by the user as voice;
judging unit which judges a manipulation procedure selected by the user while said voice output unit is outputting voice;
transition unit with which, in the case in which a manipulation procedure of a hierarchy lower in order than said manipulation procedure judged by said judging unit exists, a manipulation transitions to the lower hierarchy; and
default setting unit which sets a default manipulation procedure in a predetermined hierarchy.

8. The information processing apparatus according to claim 7,
wherein, in the case in which a default manipulation procedure is selected in a top hierarchy, said default setting unit sets manipulation procedures in all hierarchies to the default manipulation procedure.

9. The information processing apparatus according to claim 7, further comprising deciding unit which decides said manipulation procedure,
wherein, in the case in which said manipulation procedure is decided without outputting voice information on said manipulation procedure in a predetermined hierarchy, said default setting unit sets a default manipulation procedure in the hierarchy, and the transition unit returns the hierarchy to a hierarchy immediately higher in order than the hierarchy.

10. The information processing apparatus according to claim 7,
wherein, in the case in which an instruction to transition to a different hierarchy is issued during output of voice information on a manipulation procedure in a predetermined hierarchy, said voice output unit skips said manipulation procedure, for which voice is being outputted presently, and outputs voice information on a manipulation procedure of the different hierarchy as voice and, in the case in which an instruction to return to a preceding manipulation procedure is issued during output of voice information on said manipulation procedure in the predetermined hierarchy, said voice output unit outputs voice again from voice information on a manipulation procedure immediately preceding said manipulation procedure for which voice is being outputted presently.

11. The information processing apparatus according to claim 1,
wherein voice information on said manipulation procedure is a manipulation procedure name selectable by the user.

12. The information processing apparatus according to claim 1, further comprising: a plurality buttons which are associated with different manipulation procedures, respectively, and correspond to a plurality of fingers of the user; and reception unit which receives information on which of said plurality of buttons is depressed by the user,
wherein said judging unit judges a manipulation procedure corresponding to the depressed button for which information is received by said reception unit.

13. The information processing apparatus according to claim 12,
wherein said plurality of buttons can be operated with positions of the plurality of fingers fixed, respectively.

14. The information processing apparatus according to claim 12,
wherein said plurality of buttons are allocated to a part of a ten key.

15. The information processing apparatus according to claim 1,
wherein said predetermined processing apparatus is a copying machine and said manipulation procedure is a setting function for a copying manipulation selectable by the user in the copying machine.

16. The information processing apparatus according to claim 1,
wherein voice information on said manipulation procedure in a predetermined hierarchy is outputted repeatedly as voice until selection of said manipulation procedure and transition of a hierarchy is performed.

17. An information processing method in an information processing apparatus which is connectable to a manipulation procedure database in which manipulation procedures selectable by a user are described hierarchically, said information processing method comprising:
a judgment step of judging a manipulation procedure selected by the user;
a first voice output step of, in the case in which a manipulation procedure of a hierarchy lower in order than said manipulation procedure judged in said judgment step exists, outputting voice information on said manipulation procedure of the lower hierarchy;
a transition step with which, in the case in which a manipulation procedure of a hierarchy lower in order than said manipulation procedure judged in said judgment step does not exist, a manipulation transitions to a manipulation procedure of a top hierarchy which is different from a manipulation procedure of a top hierarchy of said manipulation procedure; and
a second voice output step of outputting voice information on said manipulation procedure of the top hierarchy to which the manipulation has transitioned.

18. An information processing method in an information processing apparatus which is connectable to a manipulation procedure database in which manipulation procedures selectable by a user are described hierarchically, said information processing method comprising:
a voice output step of outputting information on-a manipulation procedure selectable by the user as voice;
a judgment step of judging a manipulation procedure selected by the user while said voice output unit is outputting voice;
a transition step with which, in the case in which a manipulation procedure of a hierarchy lower in order than said manipulation procedure judged in the judgment step exists, a manipulation transitions to the lower hierarchy; and
a default setting step of setting a default manipulation procedure in a predetermined hierarchy.

19. A program for causing a computer, which is connectable to a manipulation procedure database in which manipulation procedures selectable by a user are described hierarchically, to execute:
a judgment procedure which judges a manipulation procedure selected by the user;
a first voice output procedure which, in the case in which a manipulation procedure of a hierarchy lower in order than said manipulation procedure judged by said judgment procedure exists, outputs voice information on said manipulation procedure of the lower hierarchy;
a transition procedure with which, in the case in which a manipulation procedure of a hierarchy lower in order than said manipulation procedure judged by said judgment procedure does not exist, a manipulation transitions to a manipulation procedure of a top hierarchy which is different from a manipulation procedure of a top hierarchy of said manipulation procedure; and
a second voice output procedure which outputs voice information on said manipulation procedure of the top hierarchy to which the manipulation has transitioned.

20. A program for causing a computer, which is connectable to a manipulation procedure database in which manipulation procedures selectable by a user are described hierarchically, to execute:
a voice output procedure which outputs information on a manipulation procedure selectable by the user as voice;
a judgment procedure which judges a manipulation procedure selected by the user while said voice output unit is outputting voice;
a transition procedure with which, in the case in which a manipulation procedure of a hierarchy lower in order than said manipulation procedure judged in the judgment step exists, a manipulation transitions to the lower hierarchy; and
a default setting procedure which sets a default manipulation procedure in a predetermined hierarchy.

21. A computer readable recording medium having stored therein the program according to claim 19.

22. A computer readable recording medium having stored therein the program according to claim 20.

23. An information processing apparatus comprising:
a database in which manipulation procedures selectable by a user are described hierarchically;
judging unit which judges a manipulation procedure selected by the user from said database; and
voice output unit which, in the case in which a manipulation procedure of a hierarchy lower in order than said manipulation procedure judged by said judging unit exists, outputs voice information on said manipulation procedure of the lower hierarchy.

24. An information processing method comprising:
a judgment step of judging a manipulation procedure selected by a user from a database in which manipulation procedures selectable by the user are described hierarchically; and
a voice output step of, in the case in which a manipulation procedure of a hierarchy lower in order than said manipulation procedure judged by said judging unit exists, outputting voice information on said manipulation procedure of the lower hierarchy.

25. A program for causing a computer to execute:
a judgment procedure which judges a manipulation procedure selected by a user from a database in which manipulation procedures selectable by the user are described hierarchically; and
a voice output procedure which, in the case in which a manipulation procedure of a hierarchy lower in order than said manipulation procedure judged by said judging unit exists, outputs voice information on said manipulation procedure of the lower hierarchy.

26. A computer readable recording medium having stored therein the program according to claim 25.
